(19) United States
(12) Patent Application Publication
(10) Pub. No.: US 2025/0125501 A1
(43) Pub. Date: Apr. 17, 2025

(54) CONNECTING PIECE AND BATTERY STRUCTURE

(71) Applicants: Microvast Power Systems Co., Ltd., Huzhou (CN); Microvast, Inc., Stafford, TX (US)

(72) Inventors: Guoyou DENG, Huzhou (CN); Xiaojie SHEN, Huzhou (CN); Caihui SHI, Huzhou (CN); Xiaohe LI, Huzhou (CN); Leilei ZHU, Huzhou (CN)

(73) Assignees: Microvast Power Systems Co., Ltd., Huzhou, ZJ (CN); Microvast, Inc., Stafford, TX (CN)

(21) Appl. No.: 18/912,622

(22) Filed: Oct. 11, 2024

(30) Foreign Application Priority Data
Oct. 11, 2023 (CN) 202311317940.9
Jan. 18, 2024 (CN) 202420123042.3
Jan. 18, 2024 (CN) 202420125986.4

(51) Int. Cl. H01M 50/533; H01M 50/536

(52) U.S. Cl. CPC H01M 50/533; H01M 50/536

(57) ABSTRACT

A connecting piece is provided for connecting an electrode tab and an electrode terminal. The connecting piece includes a first region and a second region. The first region is used to connect with the electrode terminal. The connecting piece has a thickness direction, and along the thickness direction, a thickness D1 of the first region is smaller than a thickness D2 of the second region; or, the connecting piece includes multiple single plates stacked along the thickness direction. The thickness of the first region for welding with the electrode terminal is set to be relatively thin so as to facilitate the welding connection between the connecting piece and the electrode terminal. The connecting piece is designed as a structure formed by stacking multiple single plates so as to facilitate the bending operation of the connecting piece.

### CROSS REFERENCE TO RELATED APPLICATIONS

This application claims priority to Chinese Patent Application Nos. 202420123042.3 and 202420125986.4, each of which is filed on Jan. 18, 2024, and claims priority to Chinese Patent Application No. 202311317940.9, filed on Oct. 11, 2023. The above-mentioned patent applications are incorporated herein by reference.

### TECHNICAL FIELD

This application relates to the field of battery technology, and in particular to a connecting piece and a battery structure.

### BACKGROUND

A battery generally includes a shell, bare cells and electrolyte placed inside the shell, and a cover plate used to seal the shell. The bare cell is provided with an electrode tab, and the cover plate is provided with an electrode terminal. The electrode tab of the bare cell needs to be electrically connected to the electrode terminal on the cover plate.

Generally, the electrode tab of the bare cell is connected to the electrode terminal on the cover plate through a connecting piece. In order to improve the current-carrying capability, the connecting piece is preferable to be thicker, but excessive thickness of the connecting piece is not conducive to welding between the connecting piece and the electrode terminal. In addition, excessive thickness of the connecting piece can also affect its bending. In order to facilitate the welding of the connecting piece with other parts, the connecting piece generally needs to be bent, and excessive thickness of the connecting piece will lead to easy breakage during its bending.

### SUMMARY

One object of the present application is to provide a connecting piece, aimed to solve the problem of a thick connecting piece affecting its welding with an electrode terminal.

Another object of the present application is to provide a connecting piece, aimed to solve the problem of a thick connecting piece affecting its bending.

An embodiment of the present application provides a connecting piece for connecting an electrode tab and an electrode terminal, wherein the connecting piece includes a first region and a second region, the first region is configured to connect with the electrode terminal; the connecting piece has a thickness direction, and along the thickness direction, a thickness of the first region is D1, and a thickness of the second region is D2, wherein D1<D2.

As an implementation, D1 and D2 satisfy: 1/10≤D1/D2<1.

As an implementation, the first region includes a first welding part for welding with the electrode terminal, and the second region includes a second welding part for welding with the electrode tab.

As an implementation, the connecting piece further has a length direction and a width direction, the first welding part and the second welding part are arranged along the length direction, a cross-sectional area of the first welding part perpendicular to the thickness direction is S1, and a cross-sectional area of the second welding part perpendicular to the length direction is S2, wherein S2≤S1.

As an implementation, the connecting piece includes multiple single plates, and the multiple single plates are stacked along the thickness direction, a notch is provided at a position corresponding to the first region on one or more single plates, the notch penetrates the one or more single plates along the thickness direction, the single plate with the notch is stacked on the single plate without the notch, the single plate without the notch is configured to contact and weld with the electrode terminal.

As an implementation, the second region includes a pre-welding part for welding and connecting the single plates together, and the pre-welding part is located adjacent to the first welding part.

As an implementation, the connecting piece further has a length direction and a width direction, the pre-welding part includes a first pre-welding part, and along the width direction, at least one side of the first welding part is provided with the first pre-welding part, and/or, the pre-welding part includes a second pre-welding part, and along the length direction, the second pre-welding part is located between the first welding part and the second welding part.

As an implementation, the connecting piece is a single-layer structure, and a groove is provided on the connecting piece at a position corresponding to the first region, a bottom surface of the connecting piece away from the groove is configured to contact and weld with the electrode terminal.

An embodiment of the present application also provides a battery structure including at least one bare cell, an electrode terminal, and the connecting piece as mentioned above, wherein one end of the connecting piece is connected to an electrode tab of the at least one bare cell, and the other end of the connecting piece is connected to the electrode terminal.

As an implementation, the battery structure further includes a shell and a cover plate, at least one end of the shell is provided with an opening, the at least one bare cell and the connecting piece are arranged inside the shell, the cover plate seals the opening, and the electrode terminal is provided on the cover plate.

An embodiment of the present application also provides a connecting piece for connecting an electrode tab and an electrode terminal, wherein the connecting piece has a thickness direction, and the connecting piece includes multiple single plates stacked along the thickness direction.

As an implementation, the connecting piece includes a first region and a second region, the first region is configured to connect with the electrode terminal; along the thickness direction, a thickness of the first region is D1, and a thickness of the second region is D2, wherein D1<D2.

As an implementation, D1 and D2 satisfy: 1/10≤D1/D2<1.

As an implementation, the first region includes a first welding part for welding with the electrode terminal, and the second region includes a second welding part for welding with the electrode tab.

As an implementation, the connecting piece further has a length direction and a width direction, the first welding part and the second welding part are arranged along the length direction, a cross-sectional area of the first welding part perpendicular to the thickness direction is S1, and a cross-sectional area of the second welding part perpendicular to the length direction is S2, wherein S2≤S1.

As an implementation, a notch is provided at a position corresponding to the first region on one or more single plates, the notch penetrates the one or more single plates along the thickness direction, the single plate with the notch is stacked on the single plate without the notch, the single plate without the notch is configured to contact and weld with the electrode terminal.

As an implementation, the second region includes a pre-welding part for welding and connecting the single plates together, and the pre-welding part is located adjacent to the first welding part.

As an implementation, the connecting piece further has a length direction and a width direction, the pre-welding part includes a first pre-welding part, and along the width direction, at least one side of the first welding part is provided with the first pre-welding part, and/or, the pre-welding part includes a second pre-welding part, and along the length direction, the second pre-welding part is located between the first welding part and the second welding part.

An embodiment of the present application also provides a battery structure including at least one bare cell, an electrode terminal, and the connecting piece as mentioned above, wherein one end of the connecting piece is connected to an electrode tab of the at least one bare cell, and the other end of the connecting piece is connected to the electrode terminal.

As an implementation, the battery structure further includes a shell and a cover plate, at least one end of the shell is provided with an opening, the at least one bare cell and the connecting piece are arranged inside the shell, the cover plate seals the opening, and the electrode terminal is provided on the cover plate.

The connecting piece provided in the embodiment of the present application, by setting the thickness in the first region, which is used for welding with the electrode terminal, to be relatively thin, facilitates the welding connection between the connecting piece and the electrode terminal and helps to address the issue of poor welding between the connecting piece and the electrode terminal being affected by the connecting piece being too thick. At the same time, on the connecting piece, only the thickness of the first region used for welding with the electrode terminal is set relatively thin, while the thickness of other parts of the connecting piece (i.e., the second region) is still set relatively thick to avoid affecting the current-carrying capability of the connecting piece.

The connecting piece provided in the embodiment of the present application, by adopting a structure where the connecting piece is formed by stacking multiple single plates and due to the relatively thin thickness and good ductility of each single plate, makes it less likely to break during bending, which facilitates the bending operation of the connecting piece and avoids the issue of poor bending being affected by the connecting piece being too thick. On the other hand, during welding, the electrode tab and/or the electrode terminal can be selected to be welded to some of the single plates in the connecting piece, which facilitates the welding operation and avoid the poor welding with the electrode tab and/or the electrode terminal being affected by the connecting piece being too thick.

### BRIEF DESCRIPTION OF THE DRAWINGS

FIG. 1 is a top view of a connecting piece in an embodiment of the present application.

FIG. 2 is a schematic cross-sectional view taken along the line A-A in FIG. 1.

FIG. 3 is a schematic cross-sectional view taken along the line B-B in FIG. 1.

FIG. 4 is a schematic diagram of the three-dimensional structure of FIG. 1 in a bent state.

FIG. 5 is a top view of a connecting piece in another embodiment of the present application.

FIG. 6 is a schematic cross-sectional view taken along the line E-E in FIG. 5.

FIG. 7 is a schematic cross-sectional view taken along the line F-F in FIG. 5.

FIG. 8 is a schematic diagram of the three-dimensional structure of FIG. 5 in a bent state.

FIG. 9 is a top view of a connecting piece in a further embodiment of the present application.

FIG. 10 is a schematic cross-sectional view taken along the line G-G in FIG. 9.

FIG. 11 is a side view of an unbent connecting piece connected to the bare cells in an embodiment of the present application.

FIG. 12 is a side view of an unbent connecting piece connected to the bare cells in another embodiment of the present application.

FIG. 13 is a side view of an unbent connecting piece connected to the bare cells in a further embodiment of the present application.

FIGS. 14a to 14f are schematic diagrams of the assembly process of the connecting piece and the bare cells in an embodiment of the present application.

FIGS. 15a to 15e are schematic diagrams of the assembly process of the connecting piece and the bare cells in another embodiment of the present application.

FIG. 16 is a schematic diagram of the three-dimensional structure of a battery cell in an embodiment of the present application.

FIG. 17 is an exploded, schematic diagram of the battery cell shown in FIG. 16.

In the figures: 1—connecting piece, 11—first region, 111—first welding part, 112—groove, 12—second region, 121—second welding part, 1211—electrode tab welding part, 122—pre-welding part, 1221—first pre-welding part, 1222—second pre-welding part, 2—single plate group, 21—single plate, 211—notch, 3—bare cell, 31—electrode tab, 32—insulation layer, 4—shell, 41—opening, 5—cover plate, 51—electrode terminal, 6—thermal conductive member, 61—clamping portion, 62—contact portion, 7—insulation sheet, 8—insulation film.

### DETAILED DESCRIPTION OF THE EMBODIMENTS

The following will provide a further detailed description of the specific implementations of the present application in conjunction with the accompanying drawings and embodiments. The following embodiments are used to illustrate the present application, but are not intended to limit the scope of the present application.

The terms “first”, “second”, “third”, “fourth”, etc. (if any) in the specification and claims of the present application are only used to distinguish similar objects, and are not intended to be used to describe a specific sequence or order.

The terms “up”, “down”, “left”, “right”, “front”, “back”, “top”, “bottom” (if any) in the specification and claims of the present application are defined based on the position of the structure in the figures and the position between the structures in the figures, only for the clarity and convenience of expressing the technical solution. It should be understood that the use of these directional words should not limit the scope of protection of the present application.

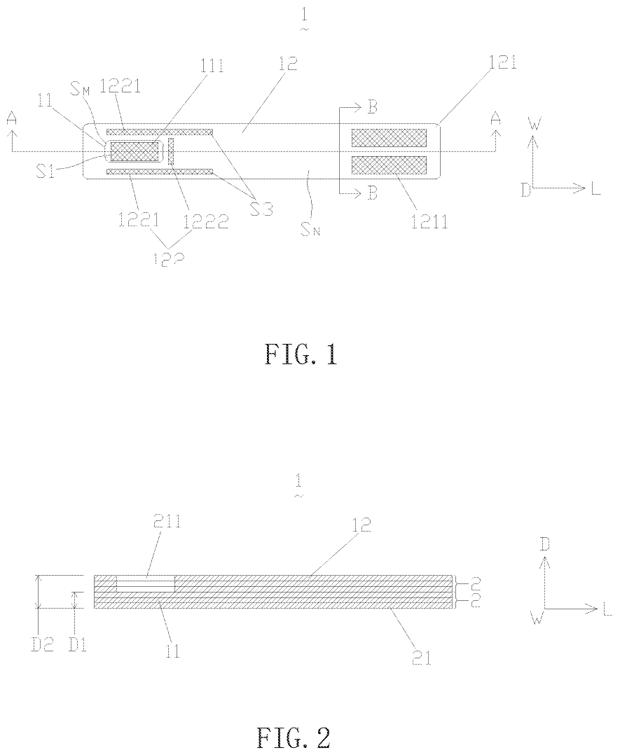

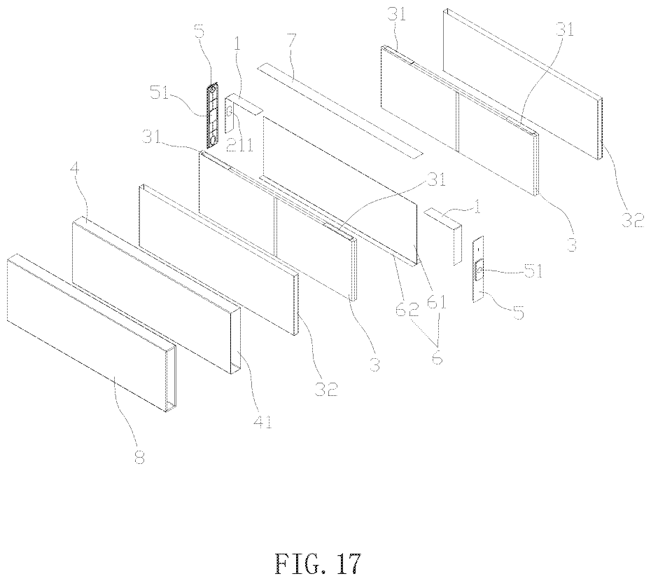

As shown in FIG. 1 and FIG. 2, a connecting piece 1 is provided in an embodiment of the present application, which is used to connect an electrode tab 31 and an electrode terminal 51 (see FIG. 17 for a schematic diagram of the electrode terminal 51 and the electrode tab 31). The connecting piece 1 includes a first region 11 and a second region 12. The second region 12 is the other region of the connecting piece 1 except for the first region 11. The first region 11 is used to connect with the electrode terminal 51. The connecting piece 1 has a thickness direction D. Along the thickness direction D of the connecting piece 1, a thickness of the first region 11 is D1, and a thickness of the second region 12 is D2, wherein D1<D2.

The connecting piece 1 provided in this embodiment is designed such that the thickness D1 in the first region 11, which is used for welding with the electrode terminal 51, is set to be relatively thin. This facilitates the welding connection between the connecting piece 1 and the electrode terminal 51, thereby addressing the issue of poor welding to the electrode terminal 51 due to the excessive thickness of the connecting piece 1.

As an implementation, D1 and D2 satisfy: 1/10≤D1/D2<1.

As an implementation, D1 and D2 satisfy: 1/5≤D1/D2≤4/5.

As an implementation, D1 and D2 satisfy: 1/4≤D1/D2≤3/4.

As an implementation, D1 and D2 satisfy: 1/3≤D1/D2≤2/3.

As an implementation, a cross-sectional area of the first region 11 perpendicular to the thickness direction D (as shown in FIG. 1, i.e., the cross-sectional area of the first region 11 parallel to the plane of the paper) is S_{M}, and a cross-sectional area of the second region 12 perpendicular to the thickness direction D (as shown in FIG. 1, i.e., the cross-sectional area of the second region 12 parallel to the plane of the paper) is S_{N}, wherein S_{M}≤S_{N}.

Since the cross-sectional area S_{M} of the first region 11 does not exceed the cross-sectional area S_{N} of the second region 12, this avoids affecting the current-carrying capacity of the connecting piece 1. Due to the relatively thin thickness D1 of the first region 11, its current-carrying capacity is relatively weak; if the cross-sectional area S_{M} of the first region 11 is too large, it will affect the overall current-carrying capacity of the connecting piece 1, and at the same time, the cross-sectional area S_{N} of the second region 12 is kept from being too small, thus avoiding inconvenience in welding with the electrode tab 31.

As shown in FIG. 1 and FIG. 2, as an implementation, S_{M} and S_{N} satisfy: S_{M}<S_{N}.

As an implementation, the first region 11 can be formed by mechanical cutting (such as milling the connecting piece 1 using a milling machine), mechanical thinning (such as squeezing and thinning the connecting piece 1 using mechanical devices), chemical etching (such as locally etching the connecting piece 1 using chemical solution), etc., to make the thickness of the first region 11 thinner than that of the second region 12.

As shown in FIG. 1 to FIG. 4, as an implementation, the connecting piece 1 includes multiple single plates 21 stacked along the thickness direction D.

In this embodiment, the connecting piece 1 is designed as a structure formed by stacking multiple single plates 21. Due to the relatively thin thickness and good ductility of each single plate 21, the connecting piece 1 is less easily to break during bending, which facilitates the bending operation and avoids the issue of poor bending being affected by the connecting piece 1 being too thick. The connecting piece 1 in FIG. 1 is in a state before bending, the connecting piece 1 in FIG. 4 is in a state after bending, and when the connecting piece 1 is bent, it is bent along its thickness direction D. Meanwhile, during welding, the electrode tab 31 and/or the electrode terminal 51 can be selected to be welded to some of the single plates 21 in the connecting piece 1, which facilitates the welding operation and helps to address the issue of poor welding with the electrode tab 31 and/or the electrode terminal 51 being affected by the connecting piece 1 being too thick.

As shown in FIG. 2 and FIG. 4, as an implementation, a notch 211 is provided at the position corresponding to the first region 11 on one or more single plates 21. That is, not all single plates 21 are provided with the notch 211. The notch 211 is located in the first region 11. Thus, by providing the notch 211, a thinner first region 11 is formed on the connecting piece 1. Specifically, the notch 211 penetrates the one or more single plates 21 along the thickness direction D. The single plate 21 with the notch 211 is stacked on the single plate 21 without the notch 211, and the single plate 21 without the notch 211 is used to contact and weld with the electrode terminal 51.

As shown in FIG. 2 and FIG. 4, as an implementation, multiple single plates 21 are provided with the notch 211, and the multiple single plates 21 with the notch 211 are stacked in sequence along the thickness direction D, so that the notches 211 on the multiple single plates 21 are aligned and communicated with each other in the thickness direction D. Along the thickness direction D, the single plates 21 with the notch 211 are stacked on the single plates 21 without the notch 211, thereby forming a groove structure on the surface of one side of the connecting piece 1. As another implementation, if the number of single plates 21 is small, for example, when the connecting piece 1 includes 2-4 single plates 21, the notch 211 can be provided only on an outermost single plate 21.

As shown in FIG. 2, FIG. 4, and FIG. 17, as an implementation, the single plates 21 with the notch 211 are located on one side of the single plates 21 without the notch 211 away from the electrode terminal 51, so that the single plates 21 without the notch 211 is located adjacent to the electrode terminal 51, and in contact with and welded to the electrode terminal 51. During welding, the electrode terminal 51 is in contact with and welded to the surface on one side of the first region 11 away from the notch 211, to realize the contact and welding between the connecting piece 1 and the electrode terminal 51.

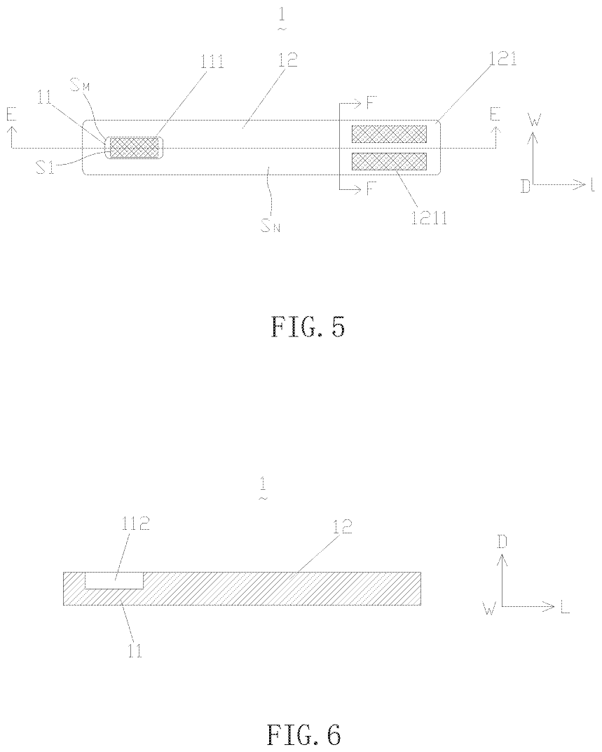

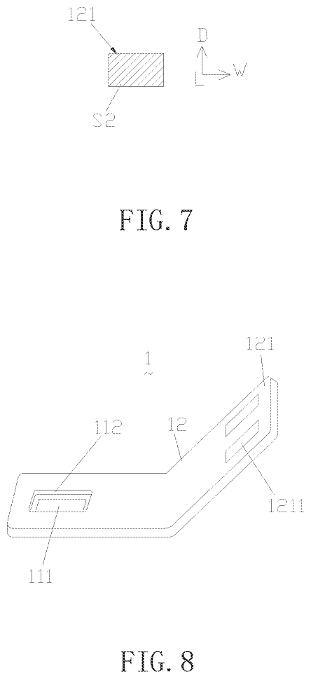

As shown in FIG. 5 to FIG. 8, as another implementation, the connecting piece 1 is a single-layer structure, that is, the entire connecting piece 1 is an integral structure. A groove 112 is provided on the connecting piece 1 at the position corresponding to the first region 11. Thus, a thinner first region 11 can be formed on the connecting piece 1. Specifically, the groove 112 does not penetrate the connecting piece 1 along the thickness direction D, and the groove 112 is located in the first region 11. The bottom surface of the connecting piece 1 away from the groove 112 is used for contacting and welding with the electrode terminal 51. During welding, the electrode terminal 51 is in contact with and welded to the surface on one side of the first region 11 away from the groove 112, to realize the contact and welding between the connecting piece 1 and the electrode terminal 51.

As an implementation, the connecting piece 1 has a rectangular sheet-like structure, and the connecting piece 1 has a length direction L and a width direction W. Every two of the length direction L, the width direction W and the thickness direction D are perpendicular to each other.

As shown in FIG. 1 to FIG. 8, the position of the notch 211 or the groove 112 corresponds to the first region 11, and the notch 211 or the groove 112 is surrounded by the second region 12. Along the width direction W, the width dimension of the first region 11 is smaller than that of the second region 12. Therefore, the second region 12 is provided around the periphery of the first region 11, and the first region 11 is enclosed by the second region 12.

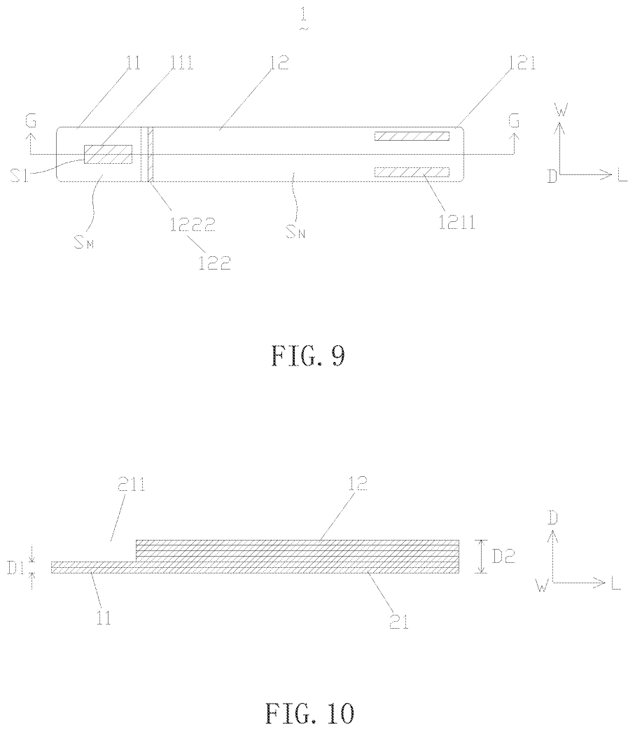

As shown in FIG. 9 and FIG. 10, as another implementation, the notch 211 is provided at a distal end of the connecting piece 1 along the length direction L. One side of the notch 211 is located adjacent to the second region 12, while the other three sides of the notch 211 are open, that is, not surrounded by the second region 12. The position of the notch 211 corresponds to the first region 11, so that the first region 11 is located at one end of the connecting piece 1 along the length direction L, and along the width direction W, the width dimension of the first region 11 is equal to that of the second region 12.

As shown in FIG. 1, as an implementation, the first region 11 includes a first welding part 111 for welding with the electrode terminal 51 (see FIG. 17 for the schematic structure of the electrode terminal 51), and the second region 12 includes a second welding part 121 for welding with the electrode tab 31 (see FIGS. 11-17 for the schematic structure of the electrode tab 31). In the length direction L of the connecting piece 1, the first welding part 111 is located at one end of the connecting piece 1, and the second welding part 121 is located at the other end of the connecting piece 1.

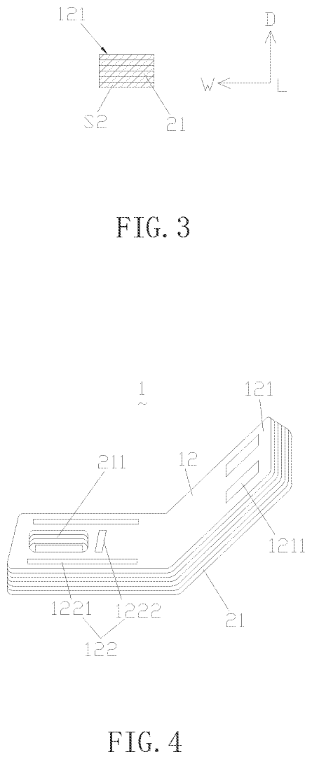

As shown in FIG. 1 and FIG. 3, as an implementation, the first welding part 111 and the second welding part 121 are arranged along the length direction L. The cross-sectional area of the first welding part 111 perpendicular to the thickness direction D (as shown in FIG. 1, i.e., the cross-sectional area of the first welding part 111 parallel to the plane of the paper) is S1, and the cross-sectional area of the second welding part 121 perpendicular to the length direction L is S2 (as shown in FIG. 3), wherein S2≤S1. Therefore, it is avoided that the cross-sectional area S1, perpendicular to the thickness direction D, of the first welding part 111 is too small, which will affect the current-carrying performance of the connecting piece 1 between the first welding part 111 and the second welding part 121.

As shown in FIG. 1 and FIG. 4, as an implementation, the second welding part 121 includes at least one electrode tab welding part 1211, and the second welding part 121 is welded to the electrode tab 31 through the electrode tab welding part 1211.

As shown in FIG. 1 and FIG. 4, as an implementation, the second welding part 121 includes two electrode tab welding parts 1211. The two electrode tab welding parts 1211 are parallel to each other in the width direction W, and each electrode tab welding part 1211 extends along the length direction L.

As shown in FIG. 1 and FIG. 4, as an implementation, the connecting piece 1 includes multiple single plates 21 stacked along the thickness direction D. A notch 211 is provided at the position corresponding to the first region 11 on one or more of the single plates 21. The single plates 21 of the connecting piece 1 are connected together by welding. Specifically, the second region 12 includes a pre-welding part 122 for welding the single plates 21 together, and the pre-welding part 122 is located adjacent to the first welding part 111. In this implementation, due to the provision of the notch 211, the current at the first welding part 111, where there are fewer single plates 21, flows through the pre-welding part 122 to the second region 12, which has more single plates 21. The pre-welding part 122 is provided close to the first welding part 111, which increases the proportion of the current transmission path in the total current-carrying path at the position with more single plates 21 (i.e., the current can be transmitted simultaneously on multiple single plates 21), thereby improving the current-carrying performance of the connecting piece 1.

As shown in FIG. 1, as an implementation, the first welding part 111 and the second welding part 121 are arranged along the length direction L, and the pre-welding part 122 includes a first pre-welding part 1221. Along the width direction W, at least one side of the first welding part 111 is provided with the first pre-welding part 1221. Because the second welding part 121 and the first welding part 111 are arranged along the length direction L, the width of the connecting piece 1 is smaller than the length of the connecting piece 1, making the width direction W of the connecting piece 1 more likely to be constrained. In this embodiment, the first pre-welding part 1221 and the first welding part 111 are extended along the length direction L, which can make the length of the first welding part 111 and the first pre-welding part 1221 longer in the length direction L. As a result, the cross-sectional area of the first welding part 111 or the first pre-welding part 1221 is relatively large, thereby improving the current-carrying capacity between the first welding part 111 and the first pre-welding part 1221.

As shown in FIG. 1, as an implementation, the first pre-welding part 1221 is provided on opposite sides of the first welding part 111 along the width direction W.

As shown in FIG. 1, as an implementation, the first welding part 111 and the second welding part 121 are arranged along the length direction L. The pre-welding part 122 further includes a second pre-welding part 1222. Along the length direction L, the second pre-welding part 1222 is located adjacent to the first welding part 111 and arranged on one side of the first welding part 111. Thus, the second pre-welding part 1222 is located between the first welding part 111 and the second welding part 121. The second pre-welding part 1222 extends along the width direction W.

As shown in FIG. 9 and FIG. 10, as another implementation, the first welding part 111 and the second welding part 121 are arranged along the length direction L, and the pre-welding part 122 only includes the second pre-welding part 1222, that is, the pre-welding part 122 does not include the first pre-welding part 1221. Along the length direction L, the second pre-welding part 1222 is located adjacent to the first welding part 111 and provided on one side of the first welding part 111, so that the second pre-welding part 1222 is located between the first welding part 111 and the second welding part 121. The second pre-welding part 1222 extends along the width direction W.

As shown in FIG. 1 and FIG. 3, as an implementation, the cross-sectional area of the second welding part 121 perpendicular to the length direction L is S2 (as shown in FIG. 3); the number of first pre-welding parts 1221 is one or more, and the sum of the cross-sectional areas of all the first pre-welding parts 1221 perpendicular to the thickness direction D (as shown in FIG. 1, i.e., the cross-sectional areas parallel to the plane of the paper of all the first pre-welding parts 1221) is S3, wherein S2≤S3.

As an implementation, the cross-sectional area of the second welding part 121 perpendicular to the length direction L is smaller than the sum of the cross-sectional areas of all the first pre-welding parts 1221 perpendicular to the thickness direction D, that is, S2<S3.

As shown in FIG. 1, as an implementation, along the length direction L, the opposite ends of the first pre-welding part 1221 respectively exceed the opposite ends of the first welding part 111 (as can be seen from FIG. 1, that is, the left and right ends of the first pre-welding part 1221 respectively exceed the left and right ends of the first welding part 111), thereby further improving the current-carrying capacity between the first welding part 111 and the first pre-welding part 1221.

As shown in FIG. 1, as an implementation, along the width direction W, the opposite ends of the second pre-welding part 1222 respectively exceed the opposite ends of the first welding part 111, thereby further improving the current-carrying capacity between the first welding part 111 and the second pre-welding part 1222.

As an implementation, the above-mentioned electrode tab 31 is a positive or negative electrode tab, and the above-mentioned electrode terminal 51 is correspondingly a positive or negative electrode terminal.

As shown in FIG. 11, an embodiment of the present application also provides a battery structure. The battery structure includes at least one bare cell 3, and a connecting piece 1 mentioned above, wherein the connecting piece 1 is connected to the electrode tab 31 of the at least one bare cell 3. The electrode tab 31 is a positive electrode tab or a negative electrode tab.

As shown in FIG. 11, as an implementation, the connecting piece 1 is connected to the electrode tabs 31 of at least two bare cells 3, and the electrode tabs 31 of the at least two bare cells 3 are connected to the surfaces of different single plates 21 in the connecting piece 1.

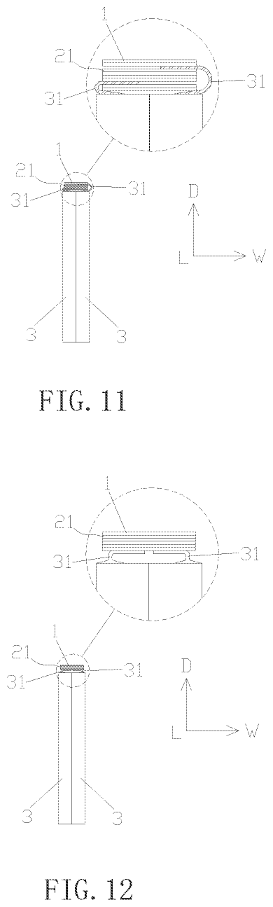

As shown in FIG. 12, as another implementation, the connecting piece 1 is connected to the electrode tabs 31 of at least two bare cells 3, and the electrode tabs 31 of the at least two bare cells are connected to the surface of the same single plate 21 in the connecting piece 1, to facilitate welding operations and improve production efficiency.

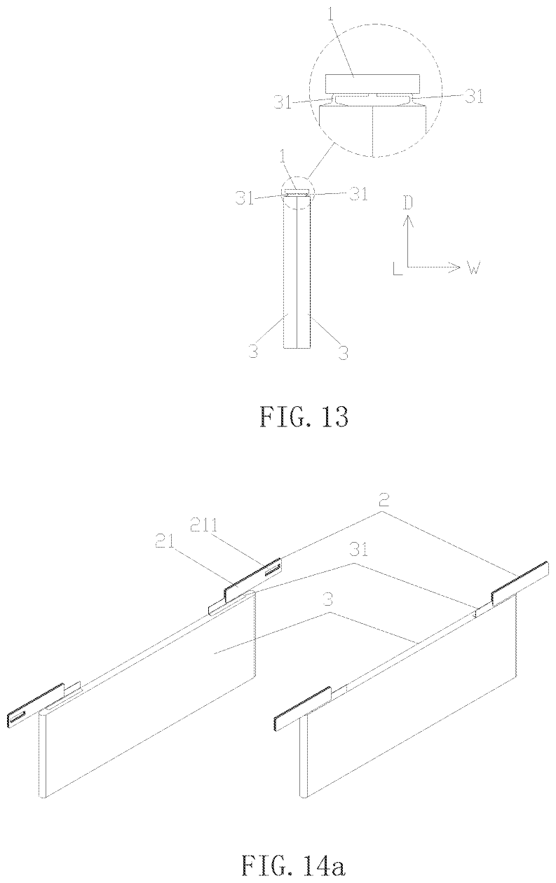

As shown in FIG. 13, as another implementation, the connecting piece 1 is a single-layer structure (i.e., the structure shown in FIGS. 5 to 8), and the connecting piece 1 is connected to the electrode tabs 31 of at least two bare cells 3. The electrode tabs 31 of the at least two bare cells 3 are connected to the surface on the same side of the connecting piece 1.

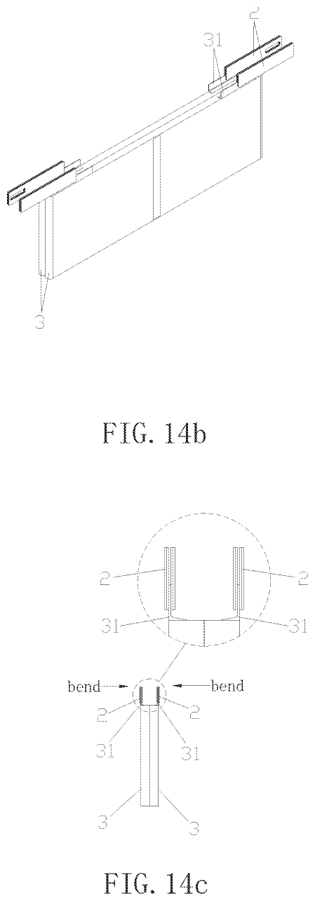

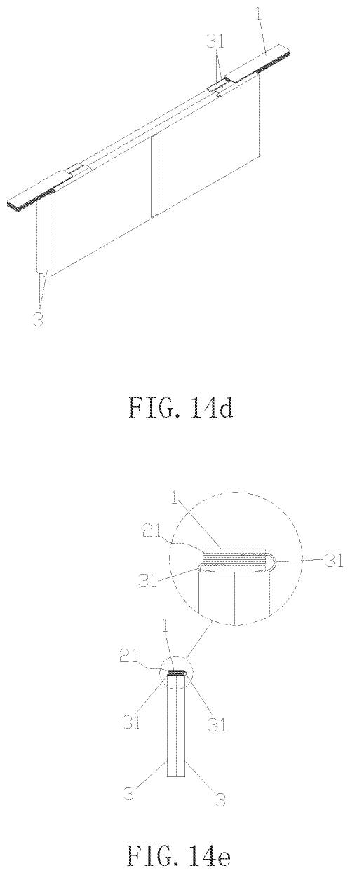

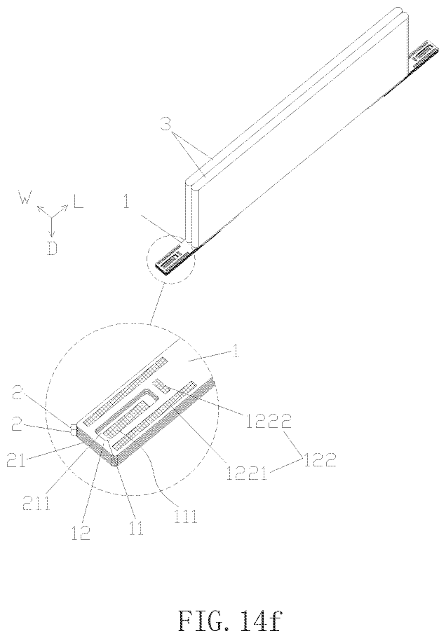

As shown in FIG. 2, FIG. 11, and FIG. 14a to FIG. 14f, as an implementation, the multiple single plates 21 in the connecting piece 1 are divided into multiple single plate groups 2 along the thickness direction D, wherein each single plate group 2 includes at least one single plate 21. The multiple single chip groups 2 are respectively welded and connected to the electrode tabs 31 of different bare cells 3. As a result, the electrode tab 31 can be welded to fewer single plates 21, thus avoiding affecting the welding of the electrode tab 31 due to the connecting piece 1 being too thick.

As shown in FIG. 2, as an implementation, each single plate group 2 includes multiple single plates 21, and the multiple single plates 21 in each single plate group 2 are stacked in sequence along the thickness direction D. As another implementation, each single plate group 2 includes one single plate 21.

As shown in FIG. 2, as an implementation, the number of single plates 21 in each single plate group 2 is the same.

As shown in FIG. 11 and FIG. 14a to FIG. 14f, as an implementation, the number of bare cells 3 is two, and the electrode tabs 31 on each bare cell 3 include a positive electrode tab and a negative electrode tab. The positive electrode tabs of the two bare cells 3 are welded and connected to the same connecting piece 1, the multiple single plates 21 in the connecting piece 1 are divided into two single plate groups 2, the positive electrode tabs of the two bare cells 3 are respectively welded and connected to the two single plate groups 2, and specifically, the positive electrode tabs of the two bare cells 3 are connected to the surfaces of different single plates 21 in the connecting piece 1. The negative electrode tabs of the two bare cells 3 are welded and connected to another connecting piece 1, the multiple single plates 21 in the another connecting piece 1 are divided into two single plate groups 2, the negative electrode tabs of the two bare cells 3 are respectively welded and connected to the two single plate groups 2 in the another connecting piece 1, and specifically, the negative electrode tabs of the two bare cells 3 are connected to the surfaces of different single plates 21 in the another connecting piece 1.

As shown in FIG. 14a to FIG. 14f, as an implementation, taking either the positive electrode tab or the negative electrode tab of the bare cell 3 as an example (in this embodiment, hereinafter, the electrode tab 31 refers to the positive electrode tab or the negative electrode tab), the connection method between the electrode tabs 31 on the bare cells 3 and the corresponding connecting piece 1 is as follows (it is noted that FIG. 14c is a side view of FIG. 14b, and FIG. 14e is a side view of FIG. 14d):

(1) As shown in FIG. 14a to FIG. 14c, the connecting piece 1 is divided into two single plate groups 2. These two single plate groups 2 are respectively welded to the electrode tabs 31 of two bare cells 3, and then the two bare cells 3 are brought together along their thickness direction. At this time, the two single plate groups 2 and the electrode tabs 31 of the two bare cells 3 are parallel to the bare cells 3 (i.e., in FIG. 14b and FIG. 14c, the electrode tabs 31 of the two bare cells 3, the two single plate groups 2, and the two bare cells 3 are all in an upright state);

(2) As shown in FIG. 14c to FIG. 14f, the two single plate groups 2 and the electrode tabs 31 of the two bare cells 3 are bent inward (i.e., in the direction of approaching each other); after bending, the two single plate groups 2 are stacked one on top of the other, and then the two stacked single plate groups 2 are welded together to form a connecting piece 1, resulting in the state shown in FIG. 14d to FIG. 14f; at this point, the electrode tabs 31 of the two bare cells 3 are connected to the surfaces of different single plates 21 in the connecting piece 1.

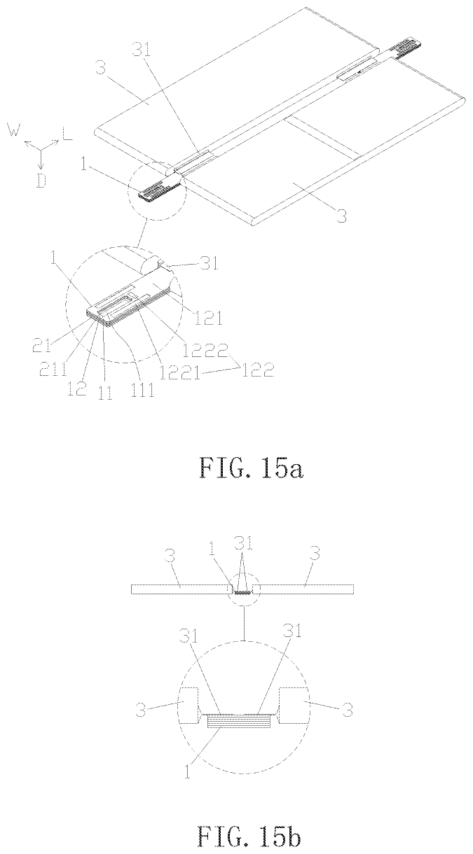

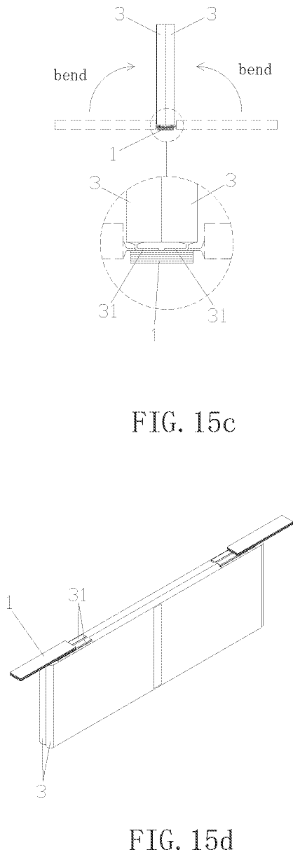

As shown in FIG. 12 and FIG. 15a to FIG. 15e, as another implementation, the number of bare cells 3 is two, and the electrode tabs 31 on each bare cell 3 include a positive electrode tab and a negative electrode tab. The positive electrode tabs of the two bare cells 3 are welded and connected to the same connecting piece 1, and the positive electrode tabs of the two bare cells 3 are connected to the surface of the same single plate 21 in the connecting piece 1. The negative electrode tabs of the two bare cells 3 are welded and connected to another connecting piece 1, and the negative electrode tabs of the two bare cells 3 are connected to the surface of the same single plate 21 in the another connecting piece 1.

As shown in FIG. 15a to FIG. 15e, as an implementation, taking either the positive electrode tab or the negative electrode tab of the bare cell 3 as an example (in this embodiment, hereinafter, the electrode tab 31 refers to the positive electrode tab or the negative electrode tab), the connection method between the electrode tabs 31 on the bare cells 3 and the connecting piece 1 is as follows (it is noted that FIG. 15b is a side view of FIG. 15a, and FIG. 15e is a side view of FIG. 15d):

(1) As shown in FIG. 15a and FIG. 15b, the two bare cells 3 are placed in a lying state, the electrode tabs 31 of the two bare cells 3 are set close to each other, and the electrode tabs 31 of the two bare cells 3 are welded and connected to the surface of the same side of the connecting piece 1;

(2) As shown in FIG. 15b and FIG. 15C, the two bare cells 3 are bent upwards at the same time, causing the electrode tabs 31 on the two bare cells 3 to bend upwards; after bending, the two bare cells 3 are brought together, resulting in the state shown in FIG. 15d and FIG. 15e; at this point, the electrode tabs 31 of the two bare cells 3 are connected to the surface of the same single plate 21 in the connecting piece 1.

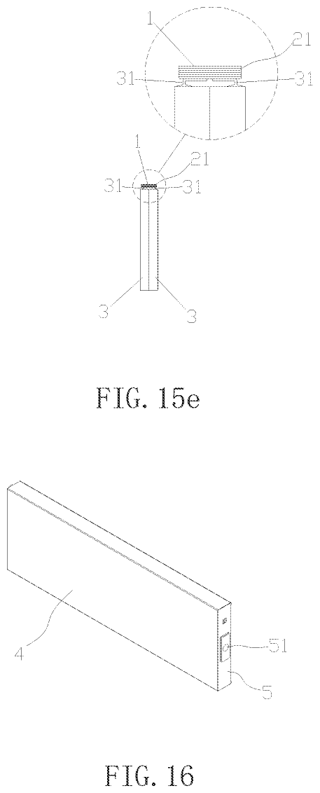

As shown in FIG. 16 and FIG. 17, this embodiment also provides a prismatic battery cell including the battery structure described above.

As shown in FIG. 16 and FIG. 17, as an implementation, the prismatic battery cell further includes a square-shaped shell 4 and a cover plate 5. The bare cells 3 and the connecting piece 1 are arranged inside the shell 4. Along the length direction of the shell 4, at least one end of the shell 4 is provided with an opening 41, and the cover plate 5 is arranged at the opening 41 and seals the opening 41.

As shown in FIG. 16 and FIG. 17, as an implementation, the cover plate 5 is provided with an electrode terminal 51, and the electrode tabs 31 of the bare cells 3 are electrically connected to the electrode terminal 51 through the connecting piece 1. Specifically, one end of the connecting piece 1 is welded to the electrode tabs 31, and the other end of the connecting piece 1 is bent and welded to the electrode terminal 51. For example, the connecting piece 1 is bent into an L-shaped structure.

Specifically, in this embodiment, along the length direction of the shell 4, the opening 41 is provided at two opposite ends of the shell 4. The openings 41 at two opposite ends of the shell 4 are each provided with the cover plate 5. The electrode terminal 51 is provided on each cover plate 5. The electrode terminal 51 on one cover plate 5 is a positive electrode terminal, and the electrode terminal 51 on the other cover plate 5 is a negative electrode terminal. The electrode tabs 31 on the bare cell 3 includes a positive electrode tab and a negative electrode tab. The positive electrode tabs of the bare cells 3 are electrically connected to the positive electrode terminal through a connecting piece 1, and the negative electrode tabs of the bare cells 3 are electrically connected to the negative electrode terminal through another connecting piece 1. That is, as shown in FIG. 17, the positive electrode tab and the negative electrode tab of the bare cell 3 are arranged on the same side of the bare cell 3, and are respectively electrically connected, through two connecting pieces 1, to the positive electrode terminal and the negative electrode terminal provided on two cover plates 5. As another implementation, a positive electrode terminal and a negative electrode terminal can be simultaneously provided on the same cover plate 5, the positive electrode tabs of the bare cells 3 are electrically connected to the positive electrode terminal through a connecting piece 1, and the negative electrode tabs of the bare cells 3 are electrically connected to the negative electrode terminal through another connecting piece 1. That is, the positive electrode tab and the negative electrode tab of the bare cell 3 may be arranged on two opposite sides of the bare cell 3, and are respectively electrically connected, through two connecting pieces 1, to the positive electrode terminal and the negative electrode terminal provided on the same cover plate 5.

As another implementation, when the shell 4 serves as the positive or negative pole of the prismatic battery cell, the shell 4 is electrically connected to the positive or negative electrode tab of the bare cell 3, wherein the shell 4 can be directly and electrically connected to the positive or negative electrode tab, or electrically connected to the positive or negative electrode tab through a connecting piece 1. The negative or positive electrode tab of the bare cell 3 that is not electrically connected to the shell 4 is electrically connected to the electrode terminal 51 through a connecting piece 1.

As shown in FIG. 17, as an implementation, multiple bare cells 3 are provided inside the shell 4 and are arranged along the thickness direction of the multiple bare cells 3. Among the multiple bare cells 3, the positive electrode tabs of at least some bare cells 3 are connected to the same connecting piece 1, and/or the negative electrode tabs of at least some bare cells 3 are connected to another connecting piece 1. In this embodiment, all the positive electrode tabs of the bare cells 3 are connected to the same connecting piece 1, and all the negative electrode tabs of the bare cells 3 are connected to another connecting piece 1. In this embodiment, the bare cells 3 are illustrated as two, but in practice, there can be more. As another implementation, in multiple bare cells 3, the positive electrode tabs of the multiple bare cells 3 can be respectively connected to multiple connecting pieces 1 in a one-to-one correspondence, and/or the negative electrode tabs of the multiple bare cells 3 can be respectively connected to additional multiple connecting pieces 1 in a one-to-one correspondence.

As shown in FIG. 17, as an implementation, the outer surface of the bare cell 3 is wrapped with an insulation layer 32, which can be PET blue film or Mylar film, etc.

As shown in FIG. 17, as an implementation, the prismatic battery cell further includes a thermal conductive member 6. The thermal conductive member 6 is located inside the shell 4. The thermal conductive member 6 includes a clamping portion 61 and a contact portion 62 that are connected to each other. The clamping portion 61 is clamped between adjacent bare cells 3, and the contact portion 62 is in contact with the inner wall of the shell 4, so that the thermal conductive member 6 can transfer the heat between the adjacent bare cells 3 to the shell 4 for heat dissipation.

As an implementation, the thermal conductive member 6 is made of a material with good thermal conductivity, such as metal.

As shown in FIG. 17, as an implementation, an insulating sheet 7 is provided between the inner wall of the shell 4 and the bare cell 3. The insulating sheet 7 is located on the side of the bare cell 3 with the electrode tabs, and the insulating sheet 7 is located between the connecting piece 1 and the inner wall of the shell 4.

As shown in FIG. 17, as an implementation, the outer wall of the shell 4 is further wrapped with an insulation film 8, such as PET film.

The connecting piece 1 provided in the embodiment of the present application, by setting the thickness D1 in the first region 11, which is used for welding with the electrode terminal 51, to be relatively thin, facilitates the welding connection between the connecting piece 1 and the electrode terminal 51 and helps to address the issue of poor welding between the connecting piece 1 and the electrode terminal 51 being affected by the connecting piece 1 being too thick. At the same time, on the connecting piece 1, only the thickness of the first region 11 used for welding with the electrode terminal 51 is set relatively thin, while the thickness of other parts of the connecting piece 1 (i.e., the second region 12) is still set relatively thick to avoid affecting the current-carrying capability of the connecting piece 1.

The connecting piece 1 provided in the embodiment of the present application, by adopting a structure where the connecting piece 1 is formed by stacking multiple single plates 21 and due to the relatively thin thickness and good ductility of each single plate 21, makes it less likely to break during bending, which facilitates the bending operation of the connecting piece 1 and avoids the issue of poor bending being affected by the connecting piece 1 being too thick. On the other hand, during welding, the electrode tab 31 and/or the electrode terminal 51 can be selected to be welded to some of the single plates 21 in the connecting piece 1, which facilitates the welding operation and avoid the poor welding with the electrode tab 31 and/or the electrode terminal 51 being affected by the connecting piece 1 being too thick.

The above are only the specific embodiments of the present application, but the scope of protection of the present application is not limited to this. Any technical personnel familiar with this technical field who can easily think of changes or replacements within the scope of technology disclosed in the present application should be covered within the scope of protection of the present application. Therefore, the protection scope of the present application should be based on the protection scope of the claims.

What is claimed is:

1. A connecting piece for connecting an electrode tab and an electrode terminal, wherein the connecting piece comprises a first region and a second region, the first region is configured to connect with the electrode terminal; the connecting piece has a thickness direction, and along the thickness direction, a thickness of the first region is D1, and a thickness of the second region is D2, wherein D1<D2.

2. The connecting piece as claimed in claim 1, wherein D1 and D2 satisfy: 1/10≤D1/D2<1.

3. The connecting piece as claimed in claim 1, wherein the first region comprises a first welding part for welding with the electrode terminal, and the second region comprises a second welding part for welding with the electrode tab.

4. The connecting piece as claimed in claim 3, wherein the connecting piece further has a length direction and a width direction, the first welding part and the second welding part are arranged along the length direction, a cross-sectional area of the first welding part perpendicular to the thickness direction is S1, and a cross-sectional area of the second welding part perpendicular to the length direction is S2, wherein S2≤S1.

5. The connecting piece as claimed in claim 3, wherein the connecting piece comprises multiple single plates, and the multiple single plates are stacked along the thickness direction, a notch is provided at a position corresponding to the first region on one or more single plates, the notch penetrates the one or more single plates along the thickness direction, the single plate with the notch is stacked on the single plate without the notch, the single plate without the notch is configured to contact and weld with the electrode terminal.

6. The connecting piece as claimed in claim 5, wherein the second region comprises a pre-welding part for welding and connecting the single plates together, and the pre-welding part is located adjacent to the first welding part.

7. The connecting piece as claimed in claim 6, wherein the connecting piece further has a length direction and a width direction, the pre-welding part comprises a first pre-welding part, and along the width direction, at least one side of the first welding part is provided with the first pre-welding part, and/or, the pre-welding part comprises a second pre-welding part, and along the length direction, the second pre-welding part is located between the first welding part and the second welding part.

8. The connecting piece as claimed in claim 3, wherein the connecting piece is a single-layer structure, and a groove is provided on the connecting piece at a position corresponding to the first region, a bottom surface of the connecting piece away from the groove is configured to contact and weld with the electrode terminal.

9. A battery structure comprising at least one bare cell, an electrode terminal, and the connecting piece as claimed in claim 1, wherein one end of the connecting piece is connected to an electrode tab of the at least one bare cell, and the other end of the connecting piece is connected to the electrode terminal.

10. The battery structure as claimed in claim 9, wherein the battery structure further comprises a shell and a cover plate, at least one end of the shell is provided with an opening, the at least one bare cell and the connecting piece are arranged inside the shell, the cover plate seals the opening, and the electrode terminal is provided on the cover plate.

11. A connecting piece for connecting an electrode tab and an electrode terminal, wherein the connecting piece has a thickness direction, and the connecting piece comprises multiple single plates stacked along the thickness direction.

12. The connecting piece as claimed in claim 11, wherein the connecting piece comprises a first region and a second region, the first region is configured to connect with the electrode terminal; along the thickness direction, a thickness of the first region is D1, and a thickness of the second region is D2, wherein D1<D2.

13. The connecting piece as claimed in claim 12, wherein D1 and D2 satisfy: 1/10≤D1/D2<1.

14. The connecting piece as claimed in claim 12, wherein the first region comprises a first welding part for welding with the electrode terminal, and the second region comprises a second welding part for welding with the electrode tab.

15. The connecting piece as claimed in claim 14, wherein the connecting piece further has a length direction and a width direction, the first welding part and the second welding part are arranged along the length direction, a cross-sectional area of the first welding part perpendicular to the thickness direction is S1, and a cross-sectional area of the second welding part perpendicular to the length direction is S2, wherein S2≤S1.

16. The connecting piece as claimed in claim 14, wherein a notch is provided at a position corresponding to the first region on one or more single plates, the notch penetrates the one or more single plates along the thickness direction, the single plate with the notch is stacked on the single plate without the notch, the single plate without the notch is configured to contact and weld with the electrode terminal.

17. The connecting piece as claimed in claim 16, wherein the second region comprises a pre-welding part for welding and connecting the single plates together, and the pre-welding part is located adjacent to the first welding part.

18. The connecting piece as claimed in claim 17, wherein the connecting piece further has a length direction and a width direction, the pre-welding part comprises a first pre-welding part, and along the width direction, at least one side of the first welding part is provided with the first pre-welding part, and/or, the pre-welding part comprises a second pre-welding part, and along the length direction, the second pre-welding part is located between the first welding part and the second welding part.

19. A battery structure comprising at least one bare cell, an electrode terminal, and the connecting piece as claimed in claim 11, wherein one end of the connecting piece is connected to an electrode tab of the at least one bare cell, and the other end of the connecting piece is connected to the electrode terminal.

20. The battery structure as claimed in claim 19, wherein the battery structure further comprises a shell and a cover plate, at least one end of the shell is provided with an opening, the at least one bare cell and the connecting piece are arranged inside the shell, the cover plate seals the opening, and the electrode terminal is provided on the cover plate.
